(19) United States
(12) Patent Application Publication
(10) Pub. No.: US 2007/0214984 A1
(43) Pub. Date: Sep. 20, 2007

(54) Rod holder device

(76) Inventors: James P. Alfano, Janesville, WI (US); Roger L. Goecks, Beloit, WI (US)

Correspondence Address: DAVID J. ARCHER, 7037 POMERY ROAD, ROCKTON, IL, 61072, US

(21) Appl. No.: 11/725,972

(22) Filed: Mar. 20, 2007

Related U.S. Application Data
(60) Provisional application No. 60/783,940, filed on Mar. 20, 2006.

(51) Int. Cl. B41F 1/28

(52) U.S. Cl. 101/407.1

(57) ABSTRACT

A rod holder device is disclosed for holding a rod in a metering head of a size press. The rod holder device includes an elongate rod holder having a tending side and a back side and a front and a back face, the rod holder defining a cavity for the removable reception therein of the rod, the cavity extending between the sides of the rod holder. The rod holder defines an extension which extends between the sides of the rod holder. The extension has a proximal and a distal end and a first and a second surface, the distal end of the extension defining a plurality of spaced notches. A clamping plate has a first and a second extremity and a first and a second edge and a first a and a second face, the clamping plate being secured to the metering head. The clamping plate defines a plurality of spaced recesses. The arrangement is such that when the notches of the extension and the recesses of the clamping plate are aligned relative to each other, each recess cooperates with a corresponding notch of the extension for permitting a secure clamping of the rod holder relative to the metering head.

### CROSS REFERENCE TO RELATED APPLICATION

The present application is a Complete application to Provisional application U.S. Ser. No. 60/783,940 filed Mar. 20, 2006. All the disclosure of U.S. Ser. No. 60/60/783,940 is incorporated herein by reference.

### FIELD OF THE INVENTION

1. Background of the Invention

The present invention relates to a rod holder device. More specifically, the present invention relates to a rod holder device for holding a rod in a metering head of a size press.

2. Background Information

A rod metering size press is a coater for applying a coating of size onto a surface of a dried web of paper. Size is applied to the surface of the web to enhance for example the printability of the resultant web.

A typical prior art rod metering size press includes a pressurized supply of size that is ejected from an applicator onto a surface of a web moving around and supported by a backing roll. The applicator thus applies a coating of the size onto the web. A blade supported by the applicator is disposed closely adjacent to the size application zone and removes any excess size from the web. The coated web supported by the backing roll is then guided between a nip defined by the backing roll and a rotatable rod disposed a small distance downstream from the application zone. The rod assists in the application of the size to the surface of the web.

A rod in a size metering press may be approximately 1 inch in diameter and can have a length of up to 35 foot according to the type of and width of the paper being coated. It is accordingly essential that the rod be securely located relative to the web being coated. To this end, the rod is rotatably supported by a rod holder.

The rod holder is secured to the downstream end of the applicator and extends across the width of the web being coated. Various pneumatic tubes and backing stops are provided to accurately control the position of the rod holder relative to the web and for controlling the pressure applied by the rotatable rod against the web extending through the nip defined between the backing roll and the rod.

In the prior art, the rod holder has been secured to the metering head or downstream end of the applicator by means of relatively complex articulated joints.

The present invention overcomes the need for such articulated joints by the provision of a series of notches and corresponding recesses defined by the rod holder and metering head. The notches and recesses cooperate with each other to permit the rod holder to be securely clamped to the metering head.

The arrangement according to the present invention reduces manufacturing costs and maintenance requirements.

A rod holder on a metering head needs to be positively retained and detachable from the head.

Prior art arrangements using an articulated clamping mechanism attached to the head often include pivoting arms or a sliding mechanism actuated by air, hydraulic or manual means.

Therefore, the primary feature of the present invention is the provision of a rod holder device for holding a rod in a metering head of a size press that overcomes the problems associated with the prior art size presses and which makes a significant contribution to the papermaking art.

Another feature of the present invention is the provision of a rod holder device for holding a rod in a metering head of a size press for a papermaking machine that is easier and less costly to manufacture when compared with prior art rod holder devices.

Other features and advantages of the present invention will be readily apparent to those skilled in the art by a consideration of the detailed description of a preferred embodiment of the present invention contained herein.

### SUMMARY OF THE INVENTION

The present invention relates to a rod holder device for holding a rod in a metering head of a size press. The rod holder device includes an elongate rod holder having a tending side and a back side and a front and a back face, the rod holder defining a cavity for the removable reception therein of the rod, the cavity extending between the sides of the rod holder. The rod holder defines an extension which extends between the sides of the rod holder. The extension has a proximal and a distal end and a first and a second surface, the distal end of the extension defining a plurality of spaced notches. A clamping plate has a first and a second extremity and a first and a second edge and a first a and a second face, the clamping plate being secured to the metering head. The clamping plate defines a plurality of spaced recesses. The arrangement is such that when the notches of the extension and the recesses of the clamping plate are aligned relative to each other, each recess cooperates with a corresponding notch of the extension for permitting a secure clamping of the rod holder relative to the metering head.

In a more specific embodiment of the present invention, the elongate rod holder is fabricated from a plastics material.

In a preferred embodiment of the present invention, the elongate rod holder is fabricated from high molecular weight polyethylene.

Additionally, the cavity permits the press fitting therein of the rod, the cavity permitting the rotatable reception therein of the rod.

Also, the extension depends from the rod holder with the proximal end of the extension being disposed between the cavity and the distal end of the extension.

More particularly, the proximal end of the extension is secured to the rod holder and each of the notches are of the same size.

Furthermore, each notch is of rectangular configuration with each notch extending from the second surface of the extension.

Moreover, the first extremity of the clamping plate cooperates with the tending side of the rod holder and the second extremity of the clamping plate cooperates with the back side of the rod holder.

The recesses are disposed adjacent to the first edge of the clamping plate, the recesses being disposed on the second face of the clamping plate such that the recesses cooperate with corresponding notches on the second surface of the extension.

In a preferred embodiment of the present invention, each recess includes chamfered edges for assisting clamping of the notches relative to the recesses.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of a rod holder device according to the present invention for holding a rod in a metering head of a size press;

FIG. 2 is a perspective view of the rod holder device shown in FIG. 1;

FIG. 3 is a perspective view of the clamping plate shown in FIG. 2 but viewed from a different angle from the view shown in FIG. 2 in order to show more clearly the disposition of the recesses;

FIG. 4 is a side elevational view of the rod holder and the device for holding the same relative to the metering head; and

FIG. 5 is bottom plan view of the rod holder showing the extension and the clamping plate.

Similar reference characters refer to similar parts throughout the various views of the drawings.

### DETAILED DESCRIPTION OF THE DRAWINGS

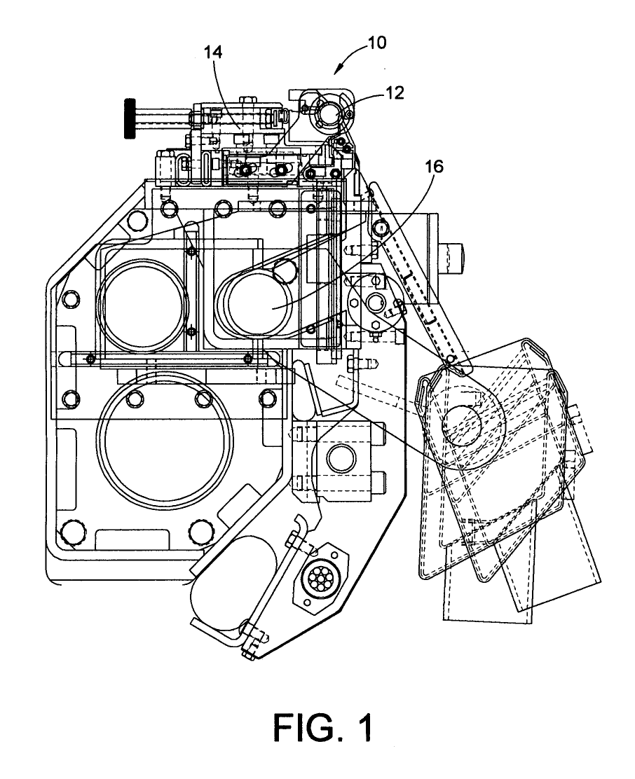

FIG. 1 is a side elevational view of a rod holder device generally designated 10 according to the present invention for holding a rod 12 in a metering head 14 of a size press 16.

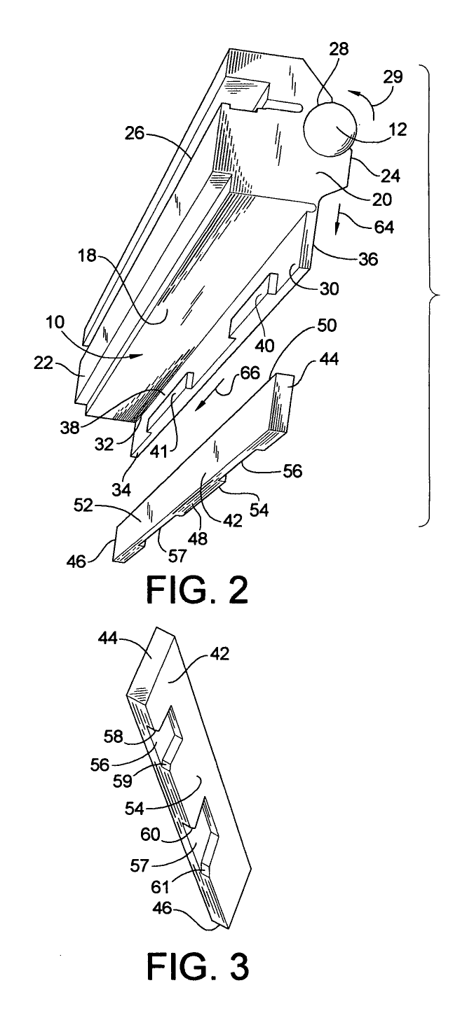

FIG. 2 is a perspective view of the rod holder device 10 shown in FIG. 1. As shown in FIG. 2, the rod holder device 10 includes an elongate rod holder 18 having a tending side 20 and a back side 22 and a front and a back face 24 and 26 respectively. The rod holder 18 defines a cavity 28 for the removable reception therein of the rod 12, the cavity 28 extending between the sides 20 and 22 of the rod holder 18. The rod holder 18 defines an extension 30 which extends between the sides 20 and 22 of the rod holder 18. The extension 30 has a proximal and a distal end 32 and 34 respectively and a first and a second surface 36 and 38 respectively, the distal end 34 of the extension 30 defining a plurality of spaced notches 40 and 41. A clamping plate 42 has a first and a second extremity 44 and 46 respectively and a first and a second edge 48 and 50 respectively and a first a and a second face 52 and 54 respectively, the clamping plate 42 being secured to the metering head 14. The clamping plate 42 defines a plurality of spaced recesses 56 and 57.

FIG. 3 is a perspective view of the clamping plate 42 shown in FIG. 2, but viewed from a different angle from the view shown in FIG. 2 in order to show more clearly the disposition of the recesses 56 and 57. The arrangement is such that when the notches 40-41 of the extension 30 and the recesses 56-57 of the clamping plate 42 are aligned relative to each other, each recess such as recess 56 cooperates with a corresponding notch 40 of the extension 30 for permitting a secure clamping of the rod holder 18 relative to the metering head 14.

In a more specific embodiment of the present invention, the elongate rod holder 18 is fabricated from a plastics material.

In a preferred embodiment of the present invention, the elongate rod holder 18 is fabricated from high molecular weight polyethylene.

Additionally, the cavity 28 permits the press fitting therein of the rod 12, the cavity 28 permitting the rotatable reception therein of the rod 12 as indicated by the arrow 29 shown in FIG. 2.

Also, the extension 30 depends from the rod holder 18 with the proximal end 32 of the extension 30 being disposed between the cavity 28 and the distal end 34 of the extension 30.

More particularly, the proximal end 32 of the extension 30 is secured to the rod holder 18 and each of the notches 40 and 41 are of the same size.

Furthermore, each notch 40 and 41 is of rectangular configuration with each notch 40 and 41 extending from the second surface 38 of the extension 30.

Moreover, the first extremity 44 of the clamping plate 42 cooperates with the tending side 20 of the rod holder 18 and the second extremity 46 of the clamping plate 42 cooperates with the back side 22 of the rod holder 18. In FIGS. 2 and 3, for clarity, the rod holder 18 is shown with only two notches 40 and 41. Those skilled in the art will appreciate that the rod holder 18 may be approximately 35 foot in length and will thus include as many as 100 notches disposed along the extension 30 thereof.

The recesses 56-57 are disposed adjacent to the first edge 48 of the clamping plate 42, the recesses 56-57 being disposed on the second face 54 of the clamping plate 42 such that the recesses 56-57 cooperate with corresponding notches 40-41 on the second surface 38 of the extension 30.

In a preferred embodiment of the present invention, each recess 56-57 as shown in FIG. 3 includes chamfered edges 58, 59, 60 and 61 respectively for assisting clamping of the notches 40-41 relative to the recesses 56-57.

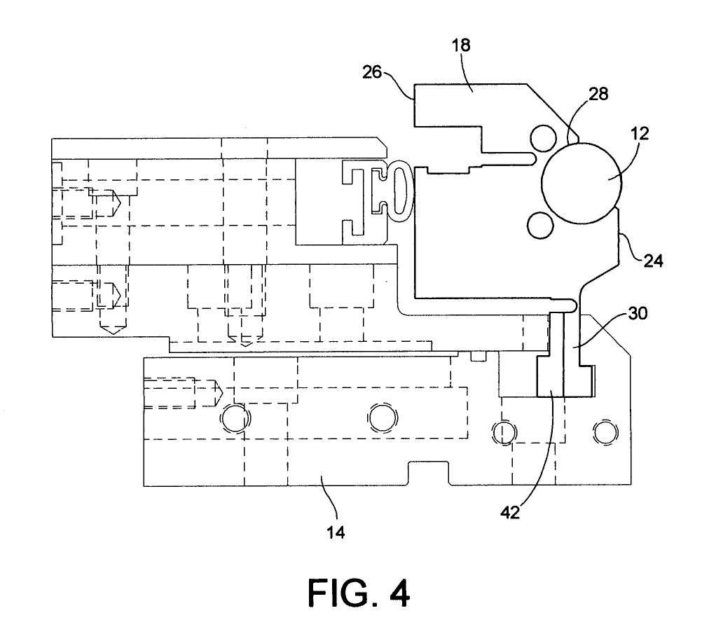

FIG. 4 is a side elevational view of the rod holder 18 and the device for holding the same relative to the metering head 14.

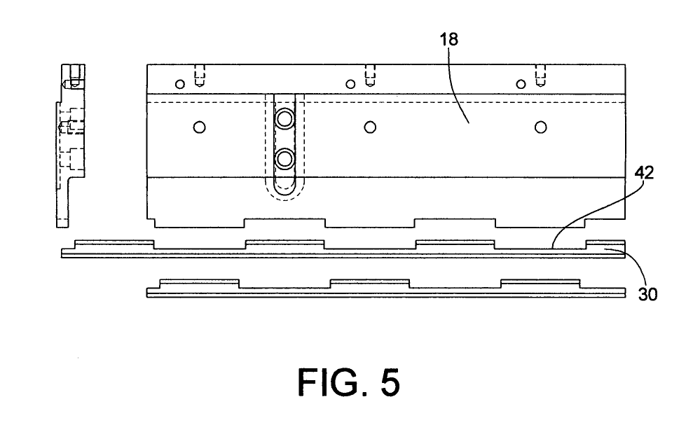

FIG. 5 is bottom plan view of the rod holder 18 showing the extension 30 and the clamping plate 42.

In operation of the device 10 according to the present invention, the rod 12 is press fitted into the cavity 28 of the rod holder 18. The extension 30 of the rod holder 18 as shown in FIG. 2 is lowered as indicated by the arrow 64 relative to the clamping plate 42. The rod holder 18 is moved laterally as indicated by the arrow 66 a short distance until the notches 40-41 engage with corresponding recesses 56-57 in the clamping plate 42. The notches 40-41 and corresponding recesses 56-57 are approximately 4 inches in length. Therefore, the amount of lateral adjustment 66 of the rod holder 18 relative to the clamping plate 42 is no more than 4 inches. The metering head 14 is then adjusted to clamp the rod holder 18 securely against the secured clamping plate 42 to accurately and positively lock the rod holder 18 relative to the metering head 14.

The present invention provides a unique rod holder device for holding a rod in a metering head of a size press that considerably reduces the cost of manufacture of a size press and which provides advantages that are not available in conventional rod holder devices.

What is claimed is:

1. A rod holder device for holding a rod in a metering head of a size press, said rod holder device comprising:
an elongate rod holder having a tending side and a back side and a front and a back face, said rod holder defining a cavity for the removable reception therein of the rod, said cavity extending between said sides of the rod holder;
said rod holder defining an extension which extends between said sides of said rod holder;
said extension having a proximal and a distal end and a first and a second surface, said distal end of said extension defining a plurality of spaced notches; and
a clamping plate having a first and a second extremity and a first and a second edge and a first a and a second face, said clamping plate being secured to the metering head, said clamping plate defining a plurality of spaced recesses, the arrangement being such that when said notches of said extension and said recesses of said clamping plate are aligned relative to each other, each recess cooperates with a corresponding notch of said extension for permitting a secure clamping of said rod holder relative to the metering head.

2. A rod holder device as set forth in claim 1 wherein
said elongate rod holder is fabricated from a plastics material.

3. A rod holder device as set forth in claim 1 wherein
said elongate rod holder is fabricated from high molecular weight polyethylene.

4. A rod holder device as set forth in claim 1 wherein
said cavity permits the press fitting therein of the rod, said cavity permitting the rotatable reception therein of the rod.

5. A rod holder device as set forth in claim 1 wherein
said extension depends from said rod holder with said proximal end of said extension being disposed between said cavity and said distal end of said extension

6. A rod holder device as set forth in claim 1 wherein
said proximal end of said extension is secured to said rod holder.

7. A rod holder device as set forth in claim 1 wherein
each of said notches are of the same size.

8. A rod holder device as set forth in claim 1 wherein
each notch is of rectangular configuration

9. A rod holder device as set forth in claim 1 wherein
each notch extends from said second surface of said extension.

10. A rod holder device as set forth in claim 1 wherein
said first extremity of said clamping plate cooperates with said tending side of said rod holder;
said second extremity of said clamping plate cooperates with said back side of said rod holder.

11. A rod holder device as set forth in claim 1 wherein
said recesses are disposed adjacent to said first edge of said clamping plate.

12. A rod holder device as set forth in claim 1 wherein
said recesses are disposed on said second face of said clamping plate such that said recesses cooperate with corresponding notches on said second surface of said extension.

13. A rod holder device as set forth in claim 1 wherein
each recess includes chamfered edges for assisting clamping of said notches relative to said recesses.

14. A rod holder device for holding a rod in a metering head of a size press, said rod holder device comprising:
an elongate rod holder having a tending side and a back side and a front and a back face, said rod holder defining a cavity for the removable reception therein of the rod, said cavity extending between said sides of the rod holder;
said rod holder defining an extension which extends between said sides of said rod holder;
said extension having a proximal and a distal end and a first and a second surface, said distal end of said extension defining a plurality of spaced notches;
a clamping plate having a first and a second extremity and a first and a second edge and a first a and a second face, said clamping plate being secured to the metering head, said clamping plate defining a plurality of spaced recesses, the arrangement being such that when said notches of said extension and said recesses of said clamping plate are aligned relative to each other, each recess cooperates with a corresponding notch of said extension for permitting a secure clamping of said rod holder relative to the metering head; and
each recess includes chamfered edges for assisting clamping of said notches relative to said recesses.

15. A rod holder device for holding a rod in a metering head of a size press, said rod holder device comprising:
an elongate rod holder having a tending side and a back side and a front and a back face, said rod holder defining a cavity for the removable reception therein of the rod, said cavity extending between said sides of the rod holder;
said rod holder defining an extension which extends between said sides of said rod holder;
said extension having a proximal and a distal end and a first and a second surface, said distal end of said extension defining a plurality of spaced notches;
a clamping plate having a first and a second extremity and a first and a second edge and a first a and a second face, said clamping plate being secured to the metering head, said clamping plate defining a plurality of spaced recesses, the arrangement being such that when said notches of said extension and said recesses of said clamping plate are aligned relative to each other, each recess cooperates with a corresponding notch of said extension for permitting a secure clamping of said rod holder relative to the metering head;
said elongate rod holder is fabricated from high molecular weight polyethylene;
said cavity permitting the press fitting therein of the rod, said cavity permitting the rotatable reception therein of the rod;
said extension depending from said rod holder with said proximal end of said extension being disposed between said cavity and said distal end of said extension;
said proximal end of said extension being secured to said rod holder;
each of said notches being of the same size;
each notch being of rectangular configuration;
each notch extending from said second surface of said extension;
said first extremity of said clamping plate cooperating with said tending side of said rod holder;
said second extremity of said clamping plate cooperating with said back side of said rod holder;
said recesses being disposed adjacent to said first edge of said clamping plate;
said recesses being disposed on said second face of said clamping plate such that said recesses cooperate with corresponding notches on said second surface of said extension; and
each recess including chamfered edges for assisting clamping of said notches relative to said recesses.
